(19) United States
(12) Patent Application Publication
(10) Pub. No.: US 2017/0206125 A1
(43) Pub. Date: Jul. 20, 2017

(54) MONITORING SYSTEM, MONITORING DEVICE, AND MONITORING PROGRAM

(71) Applicant: HITACHI, LTD., Tokyo (JP)

(72) Inventors: Yoshiteru TAKESHIMA, Tokyo (JP); Masahiko NAKAHARA, Tokyo (JP); Seiya KUDO, Tokyo (JP); Yukiko TAKEDA, Tokyo (JP)

(73) Assignee: HITACHI, LTD., Tokyo (JP)

(21) Appl. No.: 15/314,516

(22) PCT Filed: May 27, 2015
(86) PCT No.: PCT/JP2015/065156

§ 371 Date: Nov. 29, 2016

(30) Foreign Application Priority Data
May 30, 2014 (JP) 2014-113225

(51) Int. Cl. G06F 11/07

(52) U.S. Cl. CPC G06F 11/0754; G06F 11/0709

(57) ABSTRACT

A monitoring system comprises: a measurement unit; and an analysis unit, wherein the measurement unit measures traffic information relating to messages inputted to a device to be monitored and messages outputted from the device to be monitored, and wherein the analysis unit calculates one or more indices on the basis of a prescribed relational expression and the measured traffic information, and detects that a specific change in state has occurred in the device to be monitored on the basis of the indices or a comparison between a change in the indices and a threshold.

### CLAIM OF PRIORITY

The present application claims priority from Japanese patent application JP 2014-113225 filed on May 30, 2014, the content of which is hereby incorporated by reference into this application.

### BACKGROUND

The disclosed subject matter relates to a monitoring device and a monitoring program therefor.

In recent years, systems are known in which, in a network having a plurality of communication nodes (hereinafter referred to as “nodes”) connected to each other, the nodes are configured as black boxes according to device specifications, operation standards, or the like, preventing internal information such as the CPU usage rate of the node from being used.

Meanwhile, a system that uses the internal information of the node is known as a system for detecting faults in the nodes.

Japanese Patent No. 4786908 discloses a technique relating to a network troubleshooting framework for detecting and diagnosing a fault that has occurred in the network. In general, the disclosed technique detects a fault that has occurred in the network as will be described next. First, nodes that communicate with each other transmit, to a manager node, data that indicates the behavior and configuration of a network constituted of a group of nodes. The manager node is provided with a network simulation function and estimates the network performance on the basis of the received data. The manager node then determines whether the estimated network performance differs from the network performance measured by the respective nodes. If they differ, then one or more faults that are thought to be the cause thereof are evaluated.

Also, US 2013/0185038 A1 discloses a “performance calculation” device having a “data processing system modelling unit” that models a system using a mathematical model based on a birth-death process, and a “performance measure calculation unit” that calculates a performance measure in relation to a load on the system, on the basis of the mathematical model and a measured value for the service response time (see, for example, claim 32).

### SUMMARY

According to the technique disclosed in Japanese Patent No. 4786908, the manager node performs network simulation using the network setting information transmitted from the nodes (see, for example, paragraphs [0007], [0008], [0009], [0010]). The network setting information is internal information of the node measured by an agent module operating in each node, and includes signal strength, traffic statistics, and routing table information, for example (see, for example, paragraphs [0011], [0012], [0013], [0014]).

However, Japanese Patent No. 4786908 does not disclose a method for detecting a fault in a network if the network setting information cannot be measured or transmitted by the respective nodes. As described above, in some cases the nodes are black boxes according to such factors as the device specifications of the node or network operation standards, for example. In such cases, it is impossible to install the agent module in the nodes, and the manager node cannot acquire network setting information in the nodes. Thus, it is difficult for the manager node to perform network simulation using the network setting information.

According to the conventional technique, if a network system is constructed using nodes that are black boxes that contain the internal information as described above, it is difficult for the monitoring system to detect faults in the network system on the basis of internal information acquired from the nodes. Therefore, there is demand for a technique to detect communication faults in the network system without the need to acquire internal information from the nodes, for example.

Disclosed herein are a monitoring system, a monitoring device, and a monitoring program by which faults or changes in state of nodes are detected according to information inputted to devices constituting a network system and information outputted from the devices.

According to one disclosed aspect, transmission/reception traffic of one or more nodes is measured and analyzed to estimate the performance of the respective nodes.

Furthermore, in one aspect, the performance of the respective nodes is estimated a plurality of times, and change in performance is detected. If a change that exceeds a prescribed threshold is detected in a certain node, that node is detected as being faulty.

In this manner, a communication fault can be detected in the node using measurement data for network communication, and without the need for internal information of the node.

A network TAP device (hereinafter, “TAP device”) is used for measuring traffic, for example. The TAP device copies a network signal and transmits it to a measurement device. The TAP device is provided in one or more locations in the network.

In another aspect, the buffer size of the node, for example, is estimated as one aspect of node performance. Additionally, the external state of the node such as the traffic amount is measured. If an amount of traffic exceeded the estimated buffer size is detected, then in conjunction with such pieces of information, congestion may be detected to have occurred in the node. In this manner, it is possible to detect that congestion resulting from lost calls or retransmission during bursty traffic has occurred.

In yet another example, a configuration may be adopted in which the node in which the fault has occurred is identified by narrowing down step-by-step the measurement location. In this manner, an efficient and high accuracy monitoring system can be configured with a low number of TAP devices.

According to one specifically aspect, a monitoring system, comprising:

a measurement unit; and an analysis unit,

wherein the measurement unit measures traffic information relating to messages inputted to a device to be monitored and messages outputted from the device to be monitored, and

wherein the analysis unit calculates one or more indices on the basis of a prescribed relational expression and the measured traffic information, and detects that a specific change in state has occurred in the device to be monitored on the basis of the indices or a comparison between a change in the indices and a threshold.

In another aspect, a monitoring device, comprising:

a measurement section; and an analysis section,

wherein the measurement section measures traffic information relating to messages inputted to a device to be monitored and messages outputted from the device to be monitored, and

wherein the analysis section calculates one or more indices on the basis of a prescribed relational expression and the measured traffic information, and detects that a specific change in state has occurred in the device to be monitored on the basis of the indices or a comparison between a change in the indices and a threshold.

Yet another aspect is a monitoring program that, by being executed by a computer, causes the computer to function as the monitoring device.

According to the disclosure, a monitoring system, a monitoring device, and a monitoring program can be provided by which the state of nodes is detected according to information inputted to devices constituting a network and information outputted from the devices, and the detected state is used.

The details of at least one implementations of the subject matter disclosed in the specification are described with reference to the accompanying drawings and in the description below. Other features, aspects, and advantages of the subject matter will become apparent from the description, the drawings, and the claims.

### BRIEF DESCRIPTION OF THE DRAWINGS

FIG. 1 is a block diagram showing a configuration example of a network system and the monitoring system.

FIG. 2 shows a configuration example of the association setting information according to Embodiment 1.

FIG. 3 shows a configuration example of the session table.

FIG. 4 shows a configuration example of state history information according to Embodiment 1.

FIG. 5 shows a hardware configuration example of each device in the monitoring system.

FIG. 6 is a flow chart illustrating a process performed by the pre-processing unit in the traffic analysis process.

FIG. 7 is a flow chart illustrating a process performed by the pre-processing unit in the logic node classification process.

FIG. 8 is a flow chart illustrating a process performed by the pre-processing unit in the call loss extraction process.

FIG. 9 is a flow chart illustrating a process performed by the analysis unit in the system state calculation process.

FIG. 10 is a flow chart illustrating a process performed by the analysis unit in the system state determination.

FIG. 11 shows a configuration example of system configuration information according to Embodiment 3.

FIG. 12 is a flow chart illustrating a process of Embodiment 3 performed by the analysis unit in the measurement priority control process.

FIG. 13 is a flow chart illustrating a process of Embodiment 3 performed by the measurement unit in the selective signal reception process.

FIG. 14 is a schematic flow chart in a monitoring system.

### DETAILED DESCRIPTION OF THE EMBODIMENTS

### (Summary)

First, a summary of the respective embodiments will be made. A network monitoring system disclosed in the present specification monitors a network system, with the network system including a plurality of nodes, and the nodes communicating with other nodes through the network.

A network monitoring system according to one embodiment performs a state calculation process for calculating, with limited measurement information, the response characteristics of a system to be monitored with a small amount of calculation for various loads from low to high, if various types of communication traffic having differing processing loads in the system to be monitored are inputted to this system. Also, the network monitoring system performs a pre-process to differentiate various types of communication traffic having differing processing loads in the system to be monitored such that a modeling process need not be performed in the state calculation process.

During the state calculation process, the network monitoring system calculates a value indicating the internal state of the system to be monitored such as the maximum processing power, for example, in order to detect faults in the system to be monitored. By detecting changes in the value, the network monitoring system determines that the internal state or configuration of the system to be monitored has changed, and performs a state determination step that outputs an alert.

Also, the network monitoring system according to another embodiment detects at an early stage that a large number of messages have been transmitted in a burst to the system to be monitored and that the system deleted the transmitted messages before being able to store the received messages in a buffer. In order to do so, the network monitoring system stores the number of accumulated messages that are pending processing in the system to be monitored when it detects that a certain message has been transmitted to the system to be monitored. If a message that should normally be transmitted after the system to be monitored has processed the message is not detected, the network monitoring system determines that the system to be monitored has deleted the message, and furthermore, performs the pre-process to issue a notification to the state calculation process together with the stored number of accumulated messages. The network monitoring system uses the number of accumulated messages when the message has been deleted, which has been issued as a notification by the pre-process, in order to perform the state calculation process to estimate the physical state of the system to be monitored such as buffer size, for example. If the amount of communication traffic transmitted to the system to be monitored exceeds the buffer size estimated by the state calculation process, the network monitoring system detects that messages have been deleted due to buffer overflow and performs the state determination process to output the alert.

The network monitoring system according to yet another embodiment uses the pre-stored configuration information of the system to be monitored when the state determination process has detected that a change in state has occurred in a node in a system to be monitored, to perform a measurement priority control process to transmit a command to the measurement device so as to increase the measurement frequency for communication traffic surrounding nodes that are logically close to the node where the state change was detected and decrease the frequency of other communication traffic. When the network monitoring system receives a command from the measurement priority control process, it performs a selective signal reception process to change the measurement frequency according to the command.

### Embodiment 1

Next, Embodiment 1 will be described with reference to the drawings. Here, an embodiment will be disclosed using an example of fault detection in a network system.

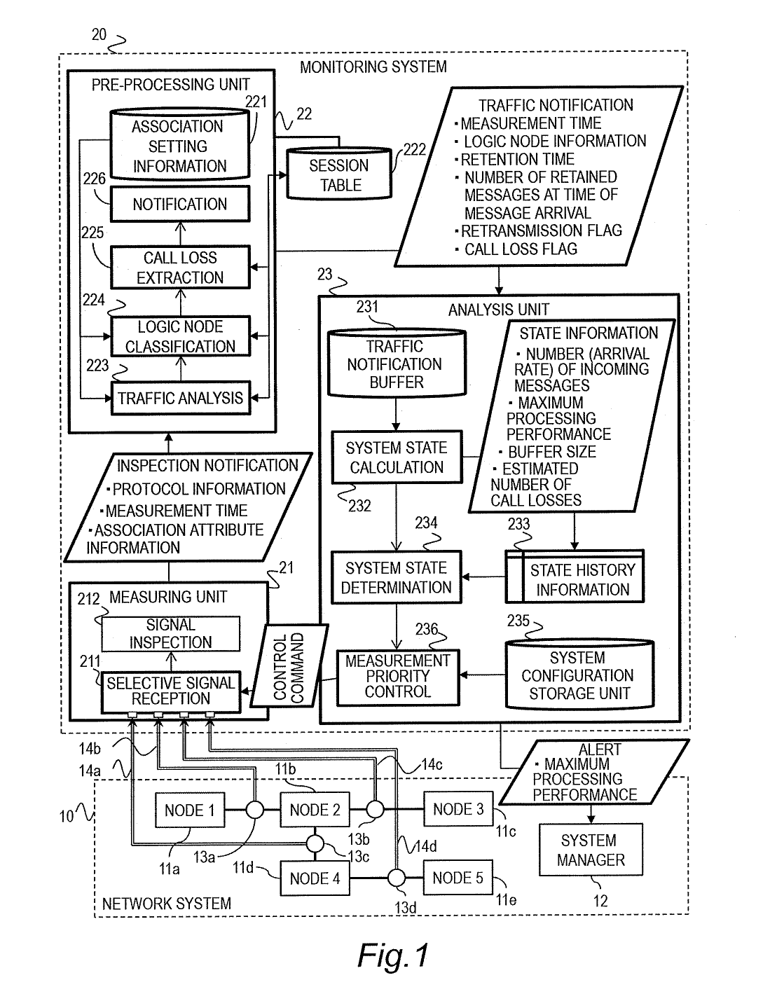

A configuration example of respective components constituting a monitoring system 20 will be described with reference to FIGS. 1 to 4.

FIG. 1 is a block diagram showing a configuration example of a network system 10 and the monitoring system 20. The network system 10 includes a plurality of nodes 11 forming a network (indicated as 11a to 11e in the example of FIG. 1), and a system manager 12, for example. The node 11 communicates with other nodes 11 through the network. The system manager 12 manages the group of nodes 11.

The network system 10 further includes a plurality of TAP devices 13 (network TAPs; indicated as 13a to 13d in the example of FIG. 1). The TAP devices 13 copy packets transmitted through the network at prescribed measurement positions in the network system 10 and transmit the copied packets to a measurement unit 21 of the monitoring system 20 through network cables 14 (14a to 14d in the example of FIG. 1), for example.

The monitoring system 20 includes one or more, respectively, of the measurement unit 21, a pre-processing unit 22 (traffic report creation unit), and an analysis unit 23, for example. In the present embodiment, the measurement unit 21, the pre-processing unit 22, and the analysis unit 23 are described as separate devices, but the respective units may be included physically or logically inside one physical device (monitoring device). In such a case, the measurement unit 21, the pre-processing unit 22, and the analysis unit 23 are sometimes referred to, respectively, as the measurement section, pre-processing section, and analysis section of the monitoring device. The measurement unit and the analysis unit can each be installed as one hardware device, for example, in the monitoring device. The measurement unit and the analysis unit can be installed as a DPI device with an analysis function.

The measurement unit 21 monitors the network and checks communication data (messages) transmitted and received among the nodes 11 of the network 10 using the TAP devices 13 or the like. The measurement unit 21 inspects the content of the communication data using a signal inspection process 212 and transmits inspection notification data to the pre-processing unit 22.

The inspection notification data includes protocol information (including the destination IP address, source IP address, interface information, and procedure information of the message, for example), the measurement time (date/time information when message was checked, for example), and association attribute information (international mobile subscriber identity (IMSI), etc.), for example. The interface information and procedure information will be mentioned later when describing association setting information 221.

The pre-processing unit 22 receives the inspection notification data from the measurement unit 21, analyzes the inspection notification data, and calculates the communication traffic state of the network system 10, which includes one or more nodes 11. The pre-processing unit 22 transmits the calculated communication traffic state to the analysis unit 23 as traffic report data.

Here, communication traffic refers to the communication data (messages) transmitted and received by the nodes 11. The communication data includes, for example, a control signal transmitted between the plurality of nodes 11, requests for an application protocol such as hypertext transfer protocol (HTTP), and response messages. Below, the data units for communication traffic transmitted and received by the nodes 11 will be referred to as messages. The messages received by the node 11 will be referred to as incoming messages and transmitted messages will be referred to as outgoing messages. The messages may be IP packets.

The traffic report data is summary data pertaining to messages transmitted and received by the node 11, and includes retention time, which is the time from when a message is received by a certain node 11 to when the message is transmitted to another node 11, and additional information pertaining to retransmission and call loss. Details of the content of the traffic report data will be described later.

The pre-processing unit 22 includes a storage unit that stores the association setting information 221 and a storage unit that includes a session table 222. Either or both of the association setting information 221 and the session table 222 may be disposed outside of the pre-processing unit 22. FIG. 1 shows an example in which the session table 222 is outside of the pre-processing unit 22. The respective storage units for the association setting information 221 and the session table 222 may be separate storage regions in a single storage device.

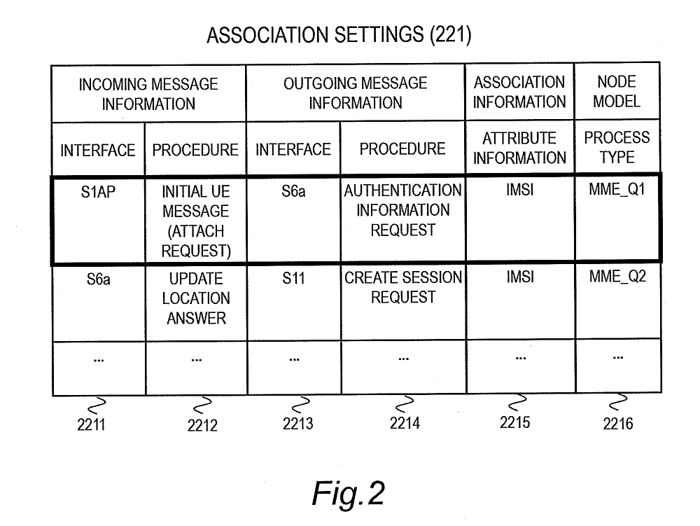

FIG. 2 shows a configuration example of the association setting information 221 according to Embodiment 1. The association setting information 221 is setting information used for a logic node classification process 224. The logic node classification process 224 is a process in which the incoming and outgoing messages in the respective nodes 11 of the network system 10 are associated with each other, a process load and a process flow from when the node 11 receives an incoming message to when it transmits the outgoing message are differentiated, and the sessions of the associated incoming and outgoing messages are classified into differing logic nodes according to the process load or process flow. The logic node and the logic node classification process 224 will be described later. The association setting information 221 is set in advance by a manager or operator.

The association setting information 221 includes, for example, interface information 2211 and procedure information 2212 of the incoming message (collectively referred to as incoming message information), interface information 2213 and procedure information 2214 of the outgoing message (collectively referred to as outgoing message information), attribute information 2215 as association information, and a process type 2216 as a node model.

The interface information (2211, 2213) is information indicating the type of communication standard among the nodes 11. The procedure information (2212, 2214) is information indicating process content included in the incoming and outgoing messages. The attribute information 2215 of the association information is used for association of the incoming messages with the outgoing messages.

If this system is applied to an evolved packet core (EPC) architecture in a wireless communication standard known as long term evolution (LTE; registered trademark) for mobile phones and the like, the interface information (2211, 2213) includes information such as “S1AP” and “S6a.” The procedure information (2212, 2214) includes information such as “attach request” or “create session request.” The attribute information 2215 includes information indicating an identification number of a mobile phone user referred to as IMSI, for example.

The process type 2216 is identification information for differentiating the process load and process flow in the node 11, from when the incoming message is received to when the outgoing message is transmitted. The process type for the process in which the incoming message is received and processed in the node 11 and an outgoing message is transmitted is designated as “YYY_Q1” (first process type), and the process type for the process in which the incoming message is received and an outgoing message is transmitted after contacting another node 11 such as a domain name system (DNS) server is designated as “YYY_Q2” (second process type), for example. If different nodes are to be contacted, then “YYY_Q2” may be further subdivided into a plurality of types such as “YYY_Q2-1” and “YYY_Q2-2.” Here, YYY is the character array indicating the type of node 11 and “MME” is inputted therein, for example. Besides this, different process types may be assigned by classifying the process type according to the length of the delay time, for example, or process types may be assigned by classifying the process type to an appropriate degree of specificity according to the processing content at the node.

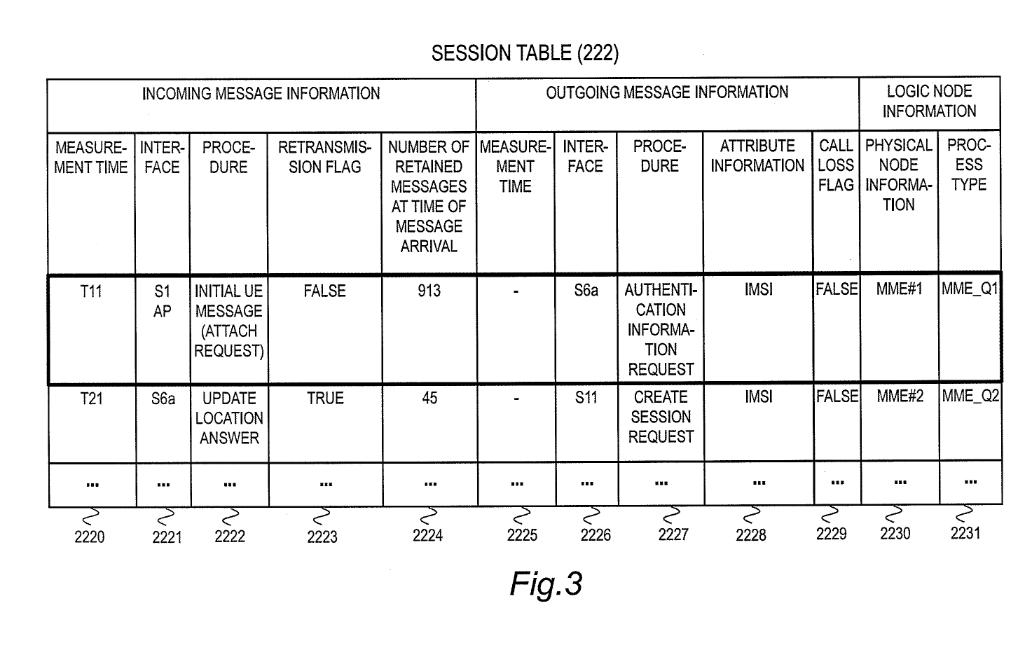

FIG. 3 shows a configuration example of the session table 222. The session table 222 is for managing the state of the association between the incoming and outgoing messages in the pre-processing unit 22 as a session.

The session table 222 includes one or more entries (session entries). Each entry in the session table 222 includes, as incoming message information, a measurement time 2220, interface information 2221, procedure information 2222, a retransmission flag 2223, and a number of retained messages at the time of message arrival 2224. Also, each entry in the session table 222 includes, as outgoing message information, a measurement time 2225, interface information 2226, procedure information 2227, attribute information 2228, and a call loss flag 2229. Furthermore, each entry in the session table 222 includes, as logic node information, physical node information 2230 and a process type 2231.

First, each element in the incoming message information and outgoing message information of the session table 222 will be described. The measurement times (2220 and 2225) are regions that store measurement time information included in the inspection notification data. The interface information (2221 and 2226) constitutes regions that store interface information (2211 or 2213) of the association setting information 221. The procedure information (2222 and 2227) constitutes regions that store procedure information (2212 or 2214) of the association setting information 221.

The retransmission flag 2223 is a region that determines that if the measurement unit 21 counts a plurality of incoming messages having the same content (that is, when the pre-processing unit 22 receives the inspection notification data for incoming messages with the same content a plurality of times), the second and subsequent incoming messages are retransmitted messages, the retransmission flag 2223 storing this determination as flag information. The number of retained messages at the time of message arrival 2224 is the number of messages that have accumulated in the same logic node when the incoming messages are being counted. In other words, it refers to the number of groups of messages where the incoming message has been counted but the outgoing message has not been counted. In one example, the number of retained messages at the time of message arrival 2224 is a value that counts the number of entries having the same logic node information in the session table 222.

The attribute information 2228 constitutes a region that stores attribute information 2215 of the association setting information 221. The call loss flag 2229 is a region that determines that if the pre-processing unit 22 has received the inspection notification data of the incoming message but has not received the inspection notification data of the corresponding outgoing message within a predetermined time period (timeout period), a call loss has occurred in the destination node 11 of the incoming message (reception node for incoming message), the call loss flag 2229 storing this determination as flag information. The information of the retransmission flag 2223 and the call loss flag 2229 is a value indicating either true or false, for example.

Next, logic node information will be described. In the present embodiment, processes in a physical node 11 are managed by separation into one or more logical nodes according to the process type. The logic node information is information for identifying the type of node to process incoming messages and output outgoing messages. The logic node information includes physical node information 2230 and the process type 2231.

The physical node information 2230 is information for physically identifying the device (hardware) of the node 11, and uses the IP address of the node 11, for example. Here, the IP address of the node 11 is the destination IP address of the incoming message, for example. In another example, it may be the source IP address of the outgoing message. The process type 2231 is the same information as the process type 2216 of the association setting information 221. Although details will be described later, the pre-processing unit 22 stores, as the process type 2231, the value for the process type 2216 of the entry searched by the association setting information 221.

The pre-processing unit 22 uses the group including the physical node information 2230 and the process type 2231 to identify the logic node. If the same node 11 receives two types of incoming messages, for example, then if the process types 2231 thereof differ from each other, then the pre-processing unit 22 determines that logic nodes which are logically different from each other received the two incoming messages. The analysis unit 23 similarly makes determinations using the logic node information.

The analysis unit 23 receives traffic report data from the pre-processing unit 22, and uses the received traffic report data and a prescribed algorithm to calculate, as state information, one or more values indicating the performance and/or internal state of the network system 10. The analysis unit 23 stores a history of the state information, calculates the amount of change in one or more values of the state information according to the state information history, and compares the amount of change with a prescribed threshold. If, as a result of this comparison, the amount of change is greater than or equal to the threshold, then the analysis unit 23 determines that the network system 10 has changed to a certain state. Detailed processes of the analysis unit 23 will be described later.

The analysis unit 23 includes a traffic report buffer 231 and a storage unit of state history information 233. The traffic report buffer 231 stores traffic report data.

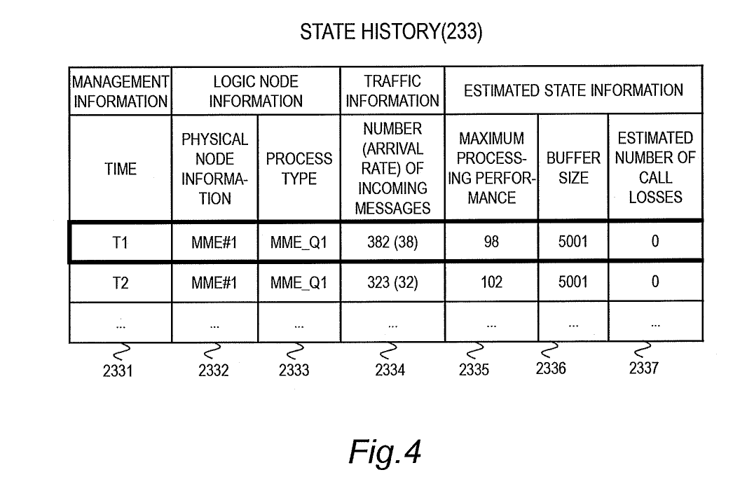

The state history information 233 will be described with reference to FIG. 4.

The state history information 233 stores information including, for example, management information 2331; physical node information 2332 and a process type 2333 as logic node information; a number of incoming messages 2334 as traffic information; and maximum processing power information 2335, a buffer size 2336, and an estimated number of call losses 2337 as estimated state information.

In one example, the analysis unit 23 includes separate storage regions for the state history 233 on the logic node information level (group of physical node information and process type) for ease of reference to estimated state information for each logic node.

The measurement time 2331 for the management information stores the measurement time extracted from the traffic report data. The physical node information 2332 and process type 2333 of the logic node information store the physical node information and process type of the logic node information extracted from the traffic report data. The number of incoming messages 2334 of the traffic information is the number of incoming messages counted on the basis of the traffic report data. The maximum processing power 2335, the buffer size 2336, and the estimated number of call losses 2337 of the estimated state information store estimated values determined by the analysis unit 23. The rate of arrival for incoming messages may be stored in addition to or instead of the number of incoming messages.

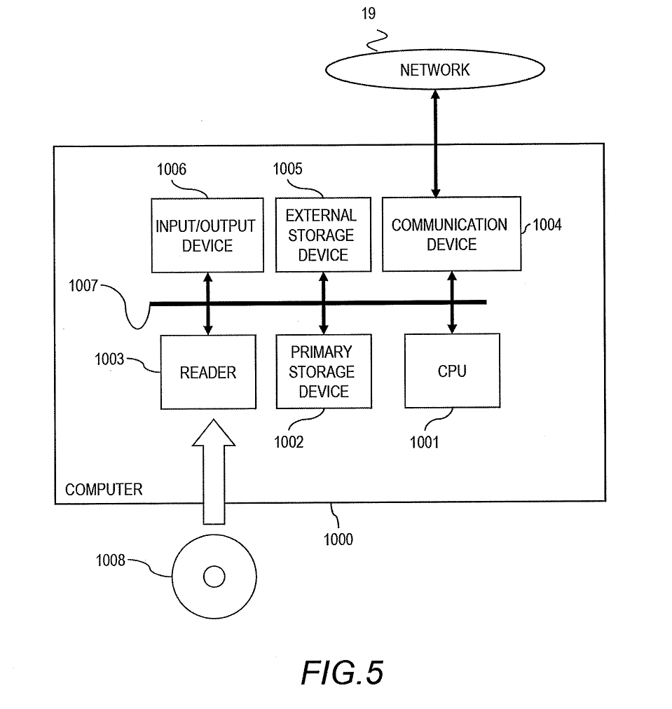

FIG. 5 shows an example of a hardware configuration of various devices such as the measurement unit 21, the pre-processing unit 22, and the analysis unit 23.

These devices can be realized by a computer 1000 including: a CPU (processing unit) 1001; a primary storage device 1002; an external storage device 1005 such as an HDD; a read device 1003 that reads information from a portable storage medium 1008 such as a CD-ROM or a DVD-ROM; an input/output device 1006 such as a display, a keyboard, or a mouse; a communication device such as a network interface card (NIC) for connecting to the network 19; and an internal communication line 1007 such as a bus for connecting these devices. Some of the components may be omitted.

The session table 222, the storage unit of the association setting information 221, and the storage unit of the state history information 233 can be realized by using a portion of the primary storage device 1002, for example.

Each device loads various programs stored in the external storage device 1005 into the primary storage device 1002 and executes these programs in the CPU 1001, and as necessary, connects to the network 19 through the communication device 1004, and communicates with other devices through the network or receives packets from the network TAP device 13, thereby realizing the respective processes and storage media in the embodiments.

Also, the programs may be stored in advance in the external storage device 1005 or, as necessary, introduced from another device through the network 19 or the storage medium 1008.

The CPU of the pre-processing unit 20 executes, respectively, the traffic analysis process 223, the logic node classification process 224, the call loss extraction process 225, and the notification process 226 shown in FIG. 1, for example. The CPU of the analysis unit 23 executes, respectively, the system state calculation process 232, the system state determination process 234, and the calculation priority control process 236 shown in FIG. 1, for example. In Embodiment 1, the calculation priority control process 236 is omitted, and will be described in Embodiment 3.

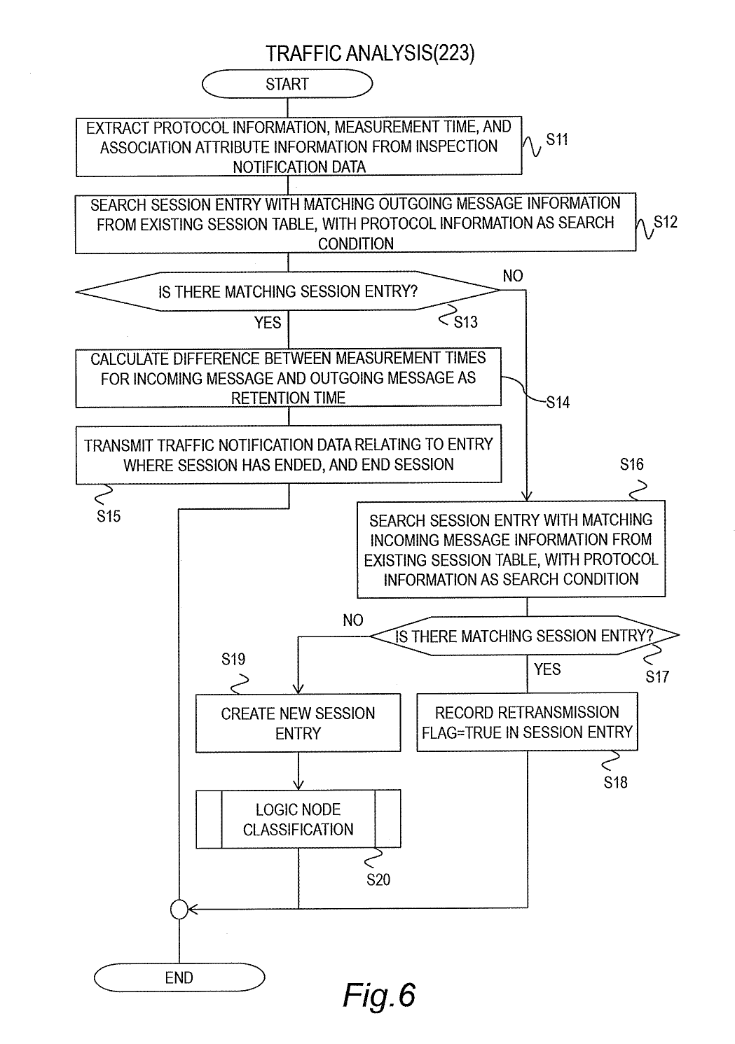

A monitoring process in the monitoring system 20 according to Embodiment 1 will be described below with reference to FIGS. 6 to 10.

(Traffic Analysis Process 223)

If the pre-processing unit 22 receives inspection notification data from the measurement unit 21, the traffic analysis process 223 extracts information necessary to perform session management in the session table 222, stores the information in the session table 222, creates traffic report data from the information needed for the analysis unit 23 to perform the analysis process, and transmits the traffic report data to the analysis unit 23.

FIG. 6 is a flow chart illustrating a process performed by the pre-processing unit 22 in the traffic analysis process 223.

First, the pre-processing unit 22 extracts, from the inspection notification data received from the measurement unit 21, protocol information (destination IP address, source IP address, interface type, and procedure information of the message), measurement time, and association attribute information (IMSI, etc.) (step S11).

Next, the pre-processing unit 22 searches the existing session table 222 for session entries with matching protocol information and outgoing message information, with the extracted protocol information as the search condition (step S12). An entry with a matching interface type and procedure information is identified, for example. Creation of new entries in the session table 222 will be described later.

If there is a matching session entry (S13, Yes), the pre-processing unit 22 calculates the difference between the measurement times of the incoming message and outgoing message as a retention time (step S14). If there is a corresponding session entry in step S13, this signifies a case where a node 11 has processed a received incoming message and outputted a corresponding outgoing message, for example. The measurement time 2220 for the incoming message is stored in a corresponding session entry, and the measurement time in the inspection notification data is used as the measurement time for the outgoing message. The pre-processing unit 22 may store the measurement time in the inspection notification data in the measurement time 2225 region of the outgoing message information of the session table 222. The calculated retention time is stored appropriately in association with the logic node information and read during the traffic report, for example.

The pre-processing unit 22 transmits to the analysis unit 23 traffic report data relating to an entry where the session has ended, deletes the corresponding session entry, and ends the process (step S15).

The traffic report data is summary information pertaining to messages transmitted and received by the node 11. The traffic report data content includes, for example, the measurement time, logic node information, retention time, number of retained messages at the time of message arrival, retransmission flag, and call loss flag.

The measurement time of the traffic report data includes the same information as the measurement time 2225 of the outgoing message information managed in the session table 222. The call loss time includes the time at which the traffic report data was generated since there is no outgoing message. The logic node information of the traffic report data includes the same information as the physical node information 2230 and the process type 2231 managed in the session table 222. The retention time of the traffic report data is the time that a message is retained in the node 11 from when the node 11 receives the message to when the message is transmitted to another node 11, and is the calculation result from step S14. The number of retained messages at the time of message arrival of the traffic report data is the same information as the number of retained messages at the time of message arrival 2224 managed in the session table 222. The retransmission flag of the traffic report data is the same information as the retransmission flag 2223 managed in the session table 222. The call loss flag of the traffic report data is the same information as the call loss flag 2229 managed in the session table 222.

On the other hand, if there are no matching session entries in step S13 (S13: No), the pre-processing unit 22 searches the existing session table 222 for session entries with matching protocol information and incoming message information, which were extracted from the inspection notification data, with the protocol information extracted from the inspection notification data as the search condition (step S16). If there is no corresponding entry in step S13, this signifies a case where after a node 11 has received an incoming message, for example, it has received an incoming message of the same content without having transmitted a corresponding outgoing message. In other words, it corresponds to a case where a retransmitted message has been received.

If there is a matching session entry in step S17 (step S17), the pre-processing unit 22 stores “TRUE” in the retransmission flag 2223 of the corresponding session entry (step S18), and ends the process.

If there is no matching session entry (step S17), the pre-processing unit 22 creates a new session entry in the session table 222 (step S19). The pre-processing unit 22 stores the measurement time, interface type, and procedure information extracted from the inspection notification data, respectively, in corresponding regions (2220-2222) of incoming message information of the new session entry.

Then, the pre-processing unit 22 progresses to the logic node classification process 224 flow (step S20).

(Logic Node Classification Process 224)

The logic node classification process 224 is a process in which, in the pre-processing unit 22, a process load and a process flow from when the node 11 receives an incoming message to when it transmits the outgoing message are differentiated, and the sessions of the associated incoming and outgoing messages are classified into differing logic nodes according to the process load or process flow.

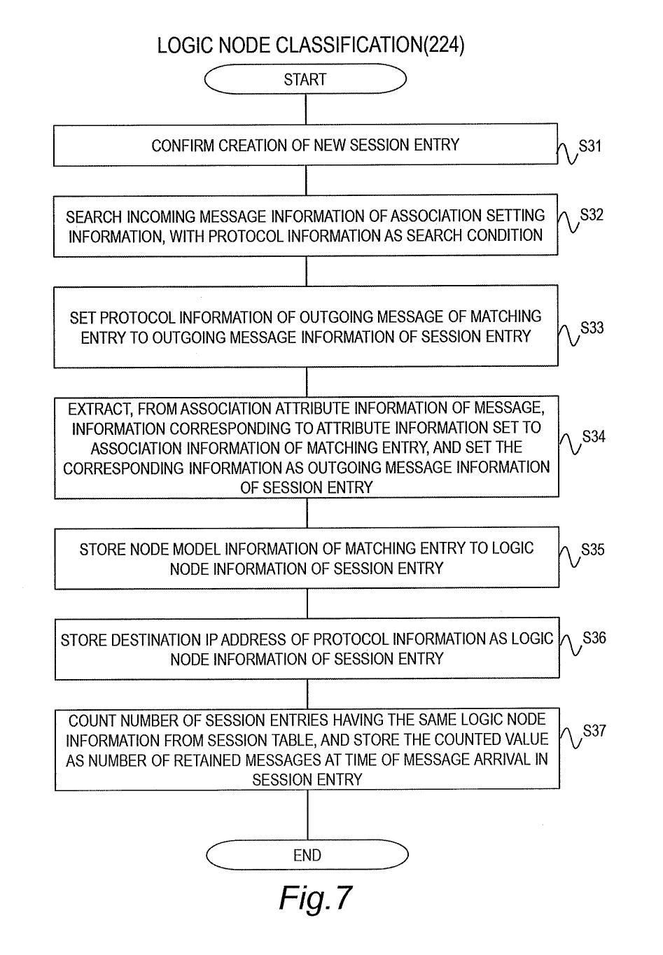

FIG. 7 is a flow chart illustrating a process performed by the pre-processing unit 22 in the logic node classification process 224.

First, the pre-processing unit 22 confirms that the new session entry creation step S19 has been completed (step S31).

Next, the pre-processing unit 22 searches the association setting information 221 for entries where the interface information 2211 and procedure information 2212 of the incoming message information match, with a combination of the interface information and procedure information of the protocol information extracted from the inspection notification data as the search conditions (step S32).

The pre-processing unit 22 sets the protocol information (including the interface information 2213 and procedure information 2214), of the outgoing message for an entry of the matching association setting information 221, to the interface information 2226 and procedure information 2227 of the outgoing message information of the new session entry (step S33). In this manner, when receiving inspection notification data from the outgoing message thereafter, it is possible to determine by steps S12 and S13 that there is a session entry that matches the outgoing message information.

Furthermore, the pre-processing unit 22 extracts, from the association attribute information of the message of the inspection notification data, information (specific identification number) corresponding to the attribute information 2215 (in one example, type information indicating the IMSI) designated by the association information of an entry with matching association setting information 221, and additionally stores the extracted information as the attribute information 2228 of the outgoing message information of the new session entry (step S34).

Furthermore, the pre-processing unit 22 stores the process type 2216 of the matching association setting information 221 entry as the process type 2231 of the logic node information of the new session entry (step S35).

Then, the pre-processing unit 22 stores the destination IP address included in the protocol information of the inspection notification data, as the physical node information 2230 of the logic node information of the new session entry (step S36).

The pre-processing unit 22 counts the number of session entries having the same logic node information (including a combination of the physical node information 2230 and process type 2231) in the session table 222, and stores this count as the number of retained messages at the time of message arrival 2224 of the new entry (step S37), and ends the process. The retransmission flag 2223 and call loss flag 2229 of new entries may be initially set as “FALSE”.

(Call Loss Extraction Process 225)

The call loss extraction process 225 is a process that determines that if the pre-processing unit 22 has received the inspection notification data of the incoming message but has not received the inspection notification data of the corresponding outgoing message within a prescribed time period (time out period), a call loss has occurred in the destination node 11 of the outgoing message (reception node for incoming message), and stores the determination standards in a corresponding session entry of the session table 222.

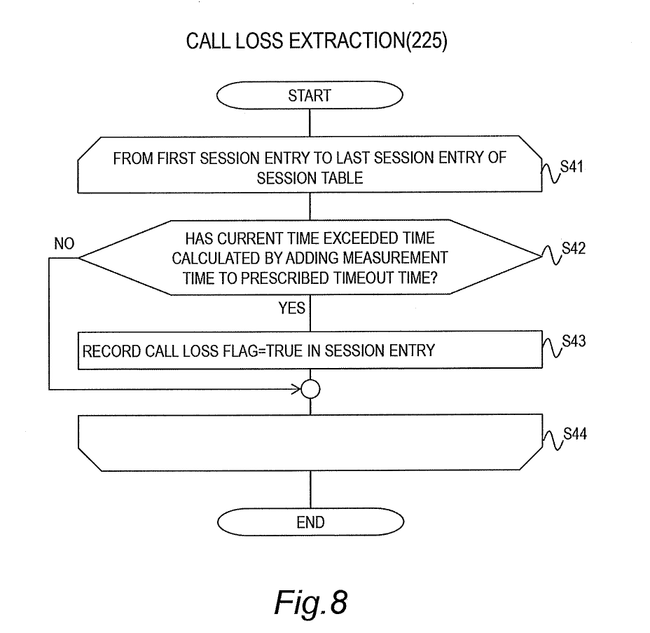

FIG. 8 is a flow chart illustrating a process performed by the pre-processing unit 22 in the call loss extraction process 225.

The pre-processing unit 22 repeats the following processes (steps S41, S44) from the first session entry to the last session entry of the session table 222. The pre-processing unit 22 determines whether the current time has exceeded a time in which a prescribed timeout time is added to the measurement time 2220 of the incoming message information (step S42). Here, in one example, a value pre-recorded in a setting file is used as the prescribed timeout time. If the time is exceeded, the pre-processing unit 22 records “TRUE” in the call loss flag 2229 of the corresponding session entry and transmits the traffic report data to the analysis unit 23 (step S43). If the time has not been exceeded, then this process is skipped and the process progresses to the next session entry.

Next, the processes in the analysis unit 23 will be described. When the analysis unit 23 receives the traffic report data from the pre-processing unit 22, it stores the traffic report data in the traffic report buffer 231.

(System State Calculation Process 232)

The system state calculation process 232 is a process in which the analysis unit 23 receives traffic report data from the pre-processing unit 22, and calculates the internal state of the logic node and, in one example, the maximum processing power from the information included in the traffic report data, in order to detect faults in each of the logic nodes.

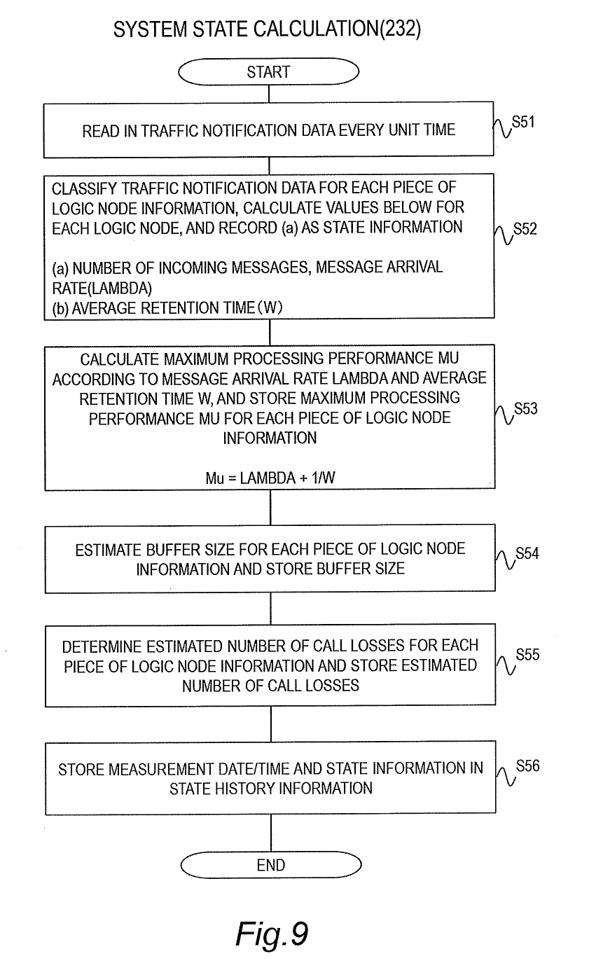

FIG. 9 is a flow chart illustrating a process performed by the analysis unit 23 in the system state calculation process 232. Here, the analysis unit 23 stores the state information in a temporary storage region. In the present embodiment, steps S54 and S55 in FIG. 9 are omitted. Steps S54 and S55 will be described in Embodiment 2.

First, the analysis unit 23 reads a plurality of pieces of buffering traffic report data from the traffic report buffer 231 for each predetermined unit time (step S51). Here, the unit time is, for example, on the order of a few seconds to tens of seconds, and a value pre-recorded in the setting file is used for the unit time.

Next, the analysis unit 23 classifies the traffic report data according to the logic node information (combination of physical node information and process type) included in the traffic report data, and performs the following calculations (a) and (b) for each piece of logic node information on the basis of the corresponding traffic report data (step S52).

(a) The number of incoming messages in the corresponding traffic report data is counted and divided by the unit time to calculate the average, and the obtained average is stored as a message arrival rate Lambda as state information. The counted number of incoming messages may also be stored in the state information. The number of incoming messages corresponds to the number of traffic reports, for example, and can be appropriately counted according to the transmission method for the traffic report data. Here, the corresponding traffic report data refers to the traffic report data within the above-mentioned unit time for prescribed logic node information.

(b) The total retention time included in the corresponding traffic report data is divided by the number of incoming messages to calculate an average, and the obtained average is stored as an average retention time W.

Next, the analysis unit 23 calculates the maximum processing power Mu for each piece of logic node information of the traffic report data on the basis of the following relational formula, and stores it as the maximum processing power Mu of the state information (step S53).

Mu=Lambda±1/W. Here, Lambda is the average message arrival rate and W is the average retention time, and values calculated in step S52 are used therefor. The above relational formula is predetermined on the basis of queuing theory. Besides determining the maximum processing power Mu for each logic node information, appropriate indices for representing the performance or state of the device may also be determined.

Next, the analysis unit 23 stores the measurement time extracted from the traffic report data, the number of incoming messages included in the state information (and/or the average message arrival rate Lambda), the physical node information and process type of the logic node information extracted from the traffic report data, and the maximum processing power Mu of the state information, respectively, as the measurement time 2331 (time rounded to the nearest unit time) of the state history information 233, the number of incoming messages (rate of arrival) 2334, the physical node information 2332 and process type 2333 of the logic node information, and the maximum processing power 2335 of the estimated state information (step S56), and then ends the process.

(System State Determination Process 234)

The system state determination process 234 is a process in which the analysis unit 23 detects a change in a value indicating the internal state of the logic node calculated in the system state calculation process 232, thereby determining that the internal state or configuration of the logic node has changed, and determines that this change indicates a fault and outputs an alert, for example.

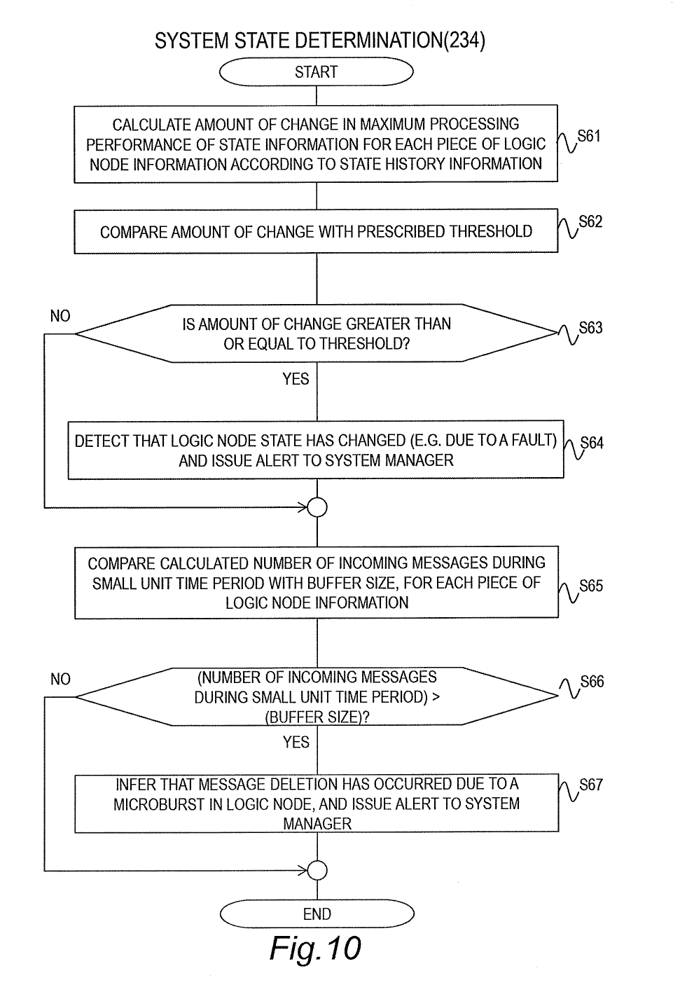

FIG. 10 is a flow chart illustrating a process performed by the analysis unit 23 in the system state determination 234.

First, the analysis unit 23 calculates, from the state history information 233, the amount of change in the maximum processing power 2335 of the estimated state information for each piece of logic node information (combination of physical node information 2332 and process type 2333) (step S61). In the state history information 233, the analysis unit 23 can, for example, calculate the amount of change in the maximum processing power 2335 from the closest two entries to the logic node under analysis because the state information is stored for each unit time. Appropriate entries other than the closest two entries may be used.

Next, the analysis unit 23 compares the amount of change with a predetermined threshold (step S62). Here, in one example, a value pre-recorded in a setting file is used as the threshold.

If the amount of change is greater than or equal to the predetermined threshold (step S63), the analysis unit 23 determines that the state of the logic node has changed, and outputs a system alert to the system manager 12 (step S64). In Embodiment 1, steps S65 to S67 are omitted. Steps S65 and S67 will be described in Embodiment 2. On the other hand, if the amount of change is not greater than or equal to the preset threshold (step S63), then after execution of step S64, the system state determination process is ended. The amount of change was used in the description above, but the rate of change may be used.

According to the present embodiment, if a few types of communication traffic having different process loads in the system are inputted to the system, then response characteristics of the system can be created in relation to the processes of the respective types of communication traffic. Also, general response characteristics for the system can be estimated using limited measurement information without the need for modeling, which requires time. Furthermore, from the measurement information, communication faults and the like can be detected in the node.

### Embodiment 2

Next, an embodiment will be described with reference to FIGS. 9 and 10 in which, if a large amount of communication traffic is inputted to the system instantaneously in a burst, the packet deletion state of the system is estimated. The physical configuration such as the buffer size of the system (node) is estimated in order to estimate packet deletion, for example.

In Embodiment 2, the retransmission flag and call loss flag are included in the traffic report data. Also, the process of the analysis unit 23 differs from that of Embodiment 1. Other configurations and processes are similar to those in Embodiment 1, and descriptions thereof are omitted.

(Description of System State Calculation Process 232)

The system state calculation process 232 of the present embodiment is a process in which the analysis unit 23 uses the call loss flag and the number of retained messages at the time of message arrival included in the traffic report data received from the pre-processing unit 22 in order to estimate the physical state of the node 11 (logic node thereof) such as the buffer size. Also, the system state calculation process 232 is a process that estimates that a large number of messages have been transmitted in a burst to a certain logic node and that the transmitted messages were deleted before the messages received by the logic node were able to be stored in the buffer, and outputs an alert.

The process of Embodiment 2 performed by the analysis unit 23 in the system state calculation process 232 will be described with reference to FIG. 9. Here, the analysis unit 23 stores the state information in a temporary storage region.

The process of steps S51 to S53 are the same as those of Embodiment 1, and thus, descriptions thereof are omitted.

Following step S53, the analysis unit 23 extracts, from the traffic report data, the logic node information (combination of physical node information and process type), the call loss flag, and the number of retained messages at the time of message arrival. Then, the analysis unit 23 determines the minimum number of retained messages at the time of message arrival for each piece of logic node information according to traffic report data where the call loss flag=TRUE. A state in which the call loss flag=TRUE is one in which the message has arrived but has not been outputted, which indicates the possibility that some packets among the number of retained messages at the time of message arrival have been deleted. Even at the minimum value for the number of retained messages at the time of message arrival determined here, it is assumed that packet deletion has occurred, and this value is used to estimate the buffer size. The analysis unit 23 stores the minimum value as the buffer size of the state information (step S54). The buffer size here is represented by the number of messages but may be represented by another unit.

Next, the analysis unit 23 determines whether the number of incoming messages exceeds the buffer size stored among the state information for each piece of logic node information (combination of physical node information and process type) in the traffic report data, and, if the buffer size is exceeded, stores the amount by which the buffer size is exceeded as the estimated number of call losses in the state information (step S55).

Next, the analysis unit 23 stores the measurement time (time rounded to the nearest unit time) extracted from the traffic report data; the number of incoming messages included in the state information (and/or the average message arrival rate Lambda); the physical node information and process type of the logic node information; and the maximum processing power Mu, buffer size, and estimated number of call losses among the state information, respectively, as the measurement time 2331 of the state history information 233; the number of incoming messages (rate of arrival) 2334; the physical node information 2332 and process type 2333 of the logic node information; and the maximum processing power 2335, buffer size 2336, and estimated number of call losses 2337 among the estimated state information (step S56), and then ends the process.

The process of Embodiment 2 performed by the analysis unit 23 in the system state determination process 234 will be described with reference to FIG. 10. Steps S61 to S64 are the same as Embodiment 1.

Next, the analysis unit 23 divides the number of incoming messages 2334 by a certain prescribed short unit of time for each piece of logic node information (combination of physical node information 2332 and process type 2333) from the storage unit of the state history information 233, thereby calculating the number of incoming messages per short unit of time, and compares the calculated value with the buffer size 2336 (steps S65, S66). Here, the short unit of time is a time period shorter than the unit time of step S51, and in one example, is a time period of approximately 100 ms to is, the short unit of time being a value stored in advance in a setting file. If the number of incoming messages per short unit of time is greater than the buffer size 2336, then the analysis unit 23 issues a system alert to the system manager 12 indicating a high probability that message deletion due to a microburst is occurring (or has occurred) in the logic node indicated by the combination of the physical node information 2332 and process type 2333 (step S67). The system alert issued to the system manager 12 may include the estimated number of call losses 2337.

The present embodiment enables the detection of congestion due to bursty traffic in the reception side node as quickly as possible. Also, if a large amount of communication traffic is inputted to the system to be monitored instantaneously in a burst, a physical configuration of this system necessary in order to estimate the packet deletion state for the system can be estimated.

### Embodiment 3

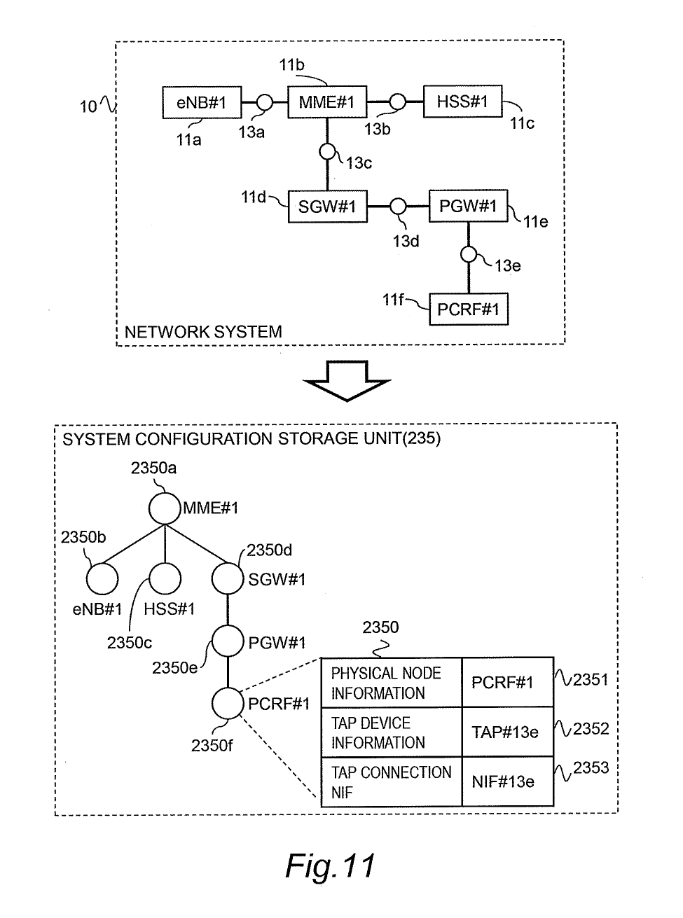

In Embodiment 3, in addition to the configurations and processes of Embodiment 1 or 2, if a fault is detected at a certain measurement point in the network system, the measurement frequency is increased for communication traffic near the measurement point where the fault was detected and the measurement frequency is decreased for other communication traffic, thereby efficiently narrowing down where the fault has occurred. The present embodiment will be described with reference to FIGS. 12, 13, and 11.

The analysis unit 23 of the present embodiment further includes a system configuration storage unit 235 (see FIG. 1). The system configuration storage unit 235 is a storage region for managing the configuration of the network system 10. Also, the CPU of the analysis unit 23 further executes measurement priority control 236. Other configurations and processes are similar to those in Embodiment 1, and descriptions thereof are omitted.

Below, a configuration example of the system configuration storage unit 235 will be described with reference to FIG. 11.

The system configuration storage unit 235 manages the system configuration (connective relationship between nodes) of the network system 10 using a tree structure. The nodes, which constitute a tree structure (data nodes 2350), include information relating to the node 11. Each data node 2350 includes physical node information 2351, TAP device information 2352, and a network interface number 2353.

The physical node information 2351 is information for physically identifying the device of the node 11 (similar to the physical node information 2230). The TAP device information 2352 is information for identifying the TAP device 13 corresponding to the node device 11. The network interface number 2353 is a region for storing the network interface number of the measurement unit 21 connected to the TAP device.

In the present embodiment, the configuration information of the network system 10 is set (stored) in advance in the system configuration storage unit 235 by a manager or operator of the network system 10.

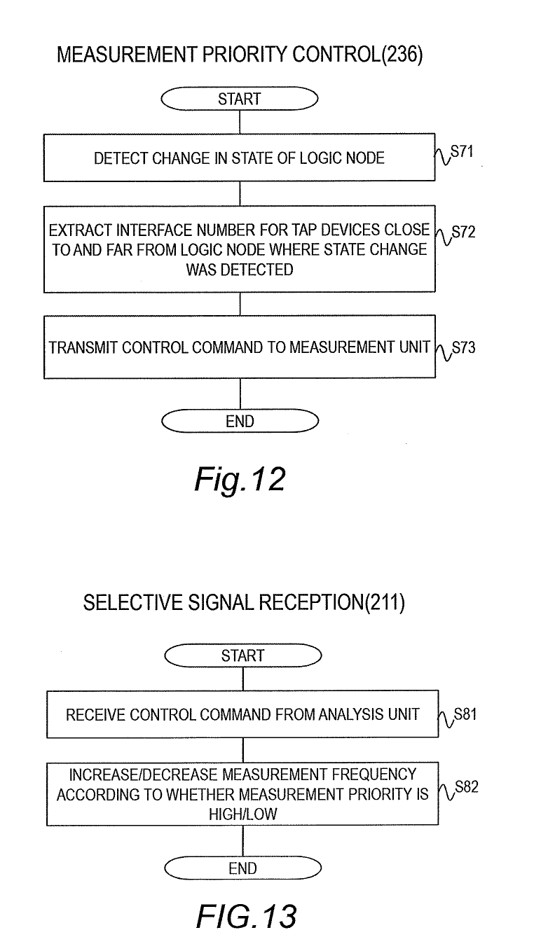

FIG. 12 is a flow chart illustrating a process of Embodiment 3 performed by the analysis unit 23 in the measurement priority control process 236.

First, the analysis unit 23 confirms that a state change (such as a fault) has been detected for a certain logic node in the system state determination process 234 described in embodiments above (step S71). A similar detection method can be used as in Embodiment 1 or 2.

Next, the analysis unit 23 uses the configuration of the network system 10 stored in the system configuration storage unit 235 and calculates the distance of each TAP device 13 from the node 11 to which the logic node for which the state change was detected belongs. Furthermore, the network interface number of the measurement unit 21 connected to each TAP device 13 is extracted from the network interface number 2353 (step S72).

The configuration example of FIG. 11 will be used to describe the method for calculating the distance of each TAP device 13. If the analysis unit 23 detects a state change in SGW#1, for example, then the number of hops between the data node 2350d and each data node 2350 is calculated. In this example, SGW#1 has 0 hops, PGW#1 has 1 hop, and HSS#1 has 2 hops. The smaller the number of hops is, the shorter the distance is in the network, and the larger the number of hops is, the longer the distance is.

The analysis unit 23 identifies one or more TAP devices 13 corresponding to a data node closer than a predetermined distance; transmits to the measurement unit 21 a control command including commands to raise the priority for the measurement process (measurement priority) to be performed for the network interface number of the measurement unit 21 connected to this TAP device 13, and lower the priority for the measurement process for network interface numbers of measurement units 21 connected to TAP devices 13 that are further than the predetermined distance (step S73); and ends the process.

FIG. 13 is a flow chart illustrating a process of Embodiment 3 performed by the measurement unit 21 in the selective signal reception process 211.

First, the measurement unit 21 receives a control command from the analysis unit 23 (step S81). Next, the measurement unit 21 raises the measurement frequency for network interface numbers with a higher measurement priority in the selective signal reception process 211. Also, the measurement unit 21 lowers the measurement frequency for network interface numbers with a lower measurement priority (step S82). The measurement unit 21 may appropriately select data received from the TAP device 13 at the measurement frequency according to the above-mentioned control command. The measurement unit 21 may output a command to modify the measurement frequency for the corresponding TAP device 13 in order to change the transmission frequency for the TAP device 13. By repeating the processes above in sequence, it is possible to accurately and gradually narrow down where the fault has occurred.

According to the present embodiment, if a fault is detected at a certain measurement point in the system to be monitored, the measurement frequency is increased for communication traffic near the measurement point where the fault was detected and the measurement frequency is decreased for other communication traffic, thereby efficiently and accurately narrowing down where the fault has occurred.

The embodiments above are examples and various modifications and applications besides those disclosed herein are possible.

### CONFIGURATION EXAMPLES

Configuration examples of the above-mentioned monitoring systems will be illustrated below.

### Configuration Examples 1

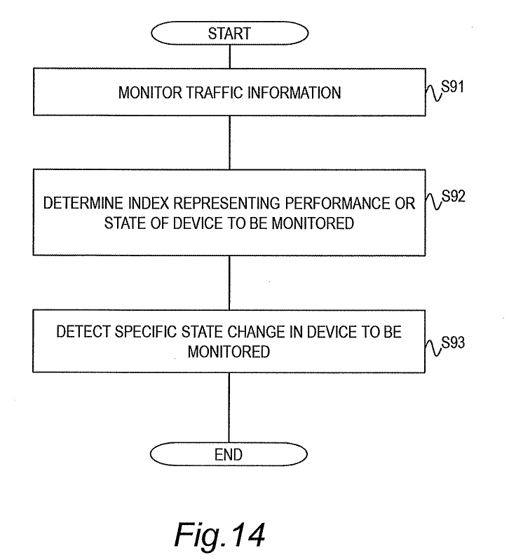

FIG. 14 is a schematic flow chart in a monitoring system.

In step S91, the measurement unit 21 measures the traffic information pertaining to messages using a device (TAP device 13 in the example of FIG. 1) to monitor messages inputted to a device (node 11 in the example of FIG. 1) to be monitored and messages outputted from the device to be monitored.

In step S92, the analysis unit 23 determines, on the basis of the measured traffic information, an index (in the example above, the maximum processing power Mu) using a relational expression between the message arrival rate to the device to be monitored, which is the number of incoming messages per unit time; the message retention time in the device to be monitored; and an index representing the performance or state of the device.

In step S93, the analysis unit 23 detects changes in state identified by the device to be monitored on the basis of changes in the deter mined index.

### Configuration Examples 2

In a monitoring system that monitors a network system,

the network system includes a plurality of nodes,

the nodes communicate with other nodes through the network,

the monitoring system includes a measurement unit, a pre-processing unit, and an analysis unit,

the measurement unit monitors the network, checks communication data transmitted and received in the network system, inspects the content of the communication data, and transmits inspection notification data to the pre-processing unit,

the pre-processing unit receives the inspection notification data from the measurement unit, analyzes the inspection notification data, calculates the communication traffic state of the network system, which includes one or more nodes, and transmits the calculated communication traffic state to the analysis unit as traffic report data, and

the analysis unit
receives traffic report data from the pre-processing unit, and uses the received traffic report data and a prescribed algorithm to calculate, as state information, one or more values indicating the performance and/or internal state of the network system, and
stores a history of the state information, calculates the amount of change in one or more values of the state information according to the state information history, compares the amount of change with a prescribed threshold, and if, as a result of the comparison, the amount of change is greater than or equal to the threshold, detects that the network system has entered a certain state.

### Configuration Examples 3

The analysis unit calculates, with limited measurement information, the response characteristics of a system to be monitored with a relatively small amount of calculation for various loads including low loads and high loads, if various types of communication traffic having differing processing loads in the network system are inputted to the network system. The pre-processing unit differentiates various types of communication traffic having differing processing loads in the network system.

### Configuration Examples 4

The analysis unit calculates one or more values indicating the internal state of the network system in order to detect faults in the network system and detects changes in the value, thereby determining that the internal state or the configuration of the network system has changed, and issues an alert.

### Configuration Examples 5

The pre-processing unit stores the number of accumulated messages that are awaiting processing in the network system when it detects that a certain message has been transmitted to the network system. If a message that should normally be transmitted after the network system has processed the message is not detected, the pre-processing unit determines that the network system has deleted the message, and furthermore, issues a notification to the analysis unit together with the stored number of accumulated messages.

The analysis unit uses the number of accumulated messages at the time of message deletion from the notification from the pre-processing unit to estimate the physical state (such as buffer size) of the network system, and if the amount of communication traffic transmitted to the network system exceeds the estimated buffer size, the analysis unit detects that messages have been deleted due to buffer overflow and outputs an alert.

### Configuration Examples 6

The analysis unit uses the pre-stored configuration information of the network system when it has been detected that a change in state has occurred in a node in the network system, and transmits a command to the measurement device to increase the measurement frequency for communication traffic surrounding the node where the state change was detected and decrease the frequency of other communication traffic.

When the measurement unit receives a command from the analysis unit, it changes the measurement frequency according to the command.

### Effects of Embodiments

Below, effects of the embodiments will be described in comparison with conventional techniques.

In the technique disclosed in US 2013/0185038 A1, the “data processing system modeling unit” creates a performance model for all communication traffic to a system to be monitored. Here, when the amount or proportion of traffic changes per type of communication traffic, if a few types of communication traffic having different process loads or the like in the system to be monitored are inputted to the system, then the performance model needs to be recreated. However, US 2013/0185038 A1 does not disclose a technique of creating a performance model individually for each communication traffic process such that the amount or proportion of traffic may change per type of communication traffic if a few types of communication traffic having different process loads in the system to be monitored are inputted to the system.

On the other hand, according to the embodiments, even if a few types of communication traffic having different process loads in the system to be monitored are inputted to the system, response characteristics of the system to be monitored can be created in relation to the processes of the respective types of communication traffic.

Also, the “performance measure calculation unit” calculates the performance value for a load amount on a system to be monitored using a mathematical model of the system that has been modeled by the “data processing system modeling unit.” Here, the mathematical model of the system to be monitored is a model of response characteristics that differs depending on the load on all communication traffic. Thus, the “performance calculation” device needs to measure the service response time for the amount of communication traffic on various loads from low to high on the system to be monitored. However, if using the disclosed technique in an application for detecting in advance a system fault such as congestion, there are cases in which communication traffic that places a heavy load on the system to be monitored cannot necessarily be detected in advance.

On the other hand, the embodiments above enable the estimation of the response characteristics of the system to be monitored according to an amount of communication traffic that does not place a heavy load on the system.

Also, from another perspective, the technique disclosed in US 2013/0185038 A1 requires a very long period of time until the model is completed to a certain degree because the mathematical model is created for the system to be monitored based on various loads. However, from the perspective of the system manager, it is not desirable for a long time to be required until the system can be monitored.

On the other hand, according to the embodiments above, the system is monitored with as short a preparation time as possible, and therefore, the response characteristics of the system to be monitored can be detected according to an amount of communication traffic that does not place a heavy load on the system. In other words, general response characteristics for the system to be monitored can be estimated using limited measurement information without the need for modeling, which requires time.

Also, in a normal network system, bursty traffic is sometimes transmitted instantaneously to a certain node from another node or group of nodes through the network. Here, if there is a buffer overflow in the reception side node, the reception side node deletes the data without being able to receive the large amount of traffic. Then, if another large amount of traffic arrives in the reception side node as a result of retransmitted traffic from the transmission side, this can cause congestion in the reception side node due to the heavy load. If congestion worsens, the reception side node sometimes goes down.

In the technique disclosed in US 2013/0185038 A1, the “data processing system modeling unit” creates a performance model for a system to be monitored using a mathematical model. If a large amount of communication traffic is inputted to the system to be monitored instantaneously in a burst, a model needs to be created for the physical state of this system such as the communication buffer size in order to incorporate in the model the probability of packet deletion in the system. However, US 2013/0185038 A1 does not disclose a technique for creating a model for a physical state such as the communication buffer size of the system to be monitored.

On the other hand, the embodiments above enable the detection of congestion due to bursty traffic in the reception side node as quickly as possible. Also, if a large amount of communication traffic is inputted to the system to be monitored instantaneously in a burst, a physical configuration of this system necessary to estimate the packet deletion state for the system can be estimated.

Also, deep packet inspection (DPI) exists as a technique to measure data in communication traffic flowing in a network. However, if the system to be monitored is large scale, then this requires a large number of DPI devices. DPI devices are very expensive. Thus, a technique that can be applied with as few DPI devices as possible is desirable.

According to the embodiments above, one DPI device is connected to the network so as to be able to measure a plurality of locations, for example, and if a fault is detected at a certain measurement point in the system to be monitored, the measurement frequency is increased for communication traffic near the measurement point where the fault was detected and the measurement frequency is decreased for other communication traffic, thereby efficiently and accurately narrowing down where the fault has occurred.

Although the present disclosure has been described with reference to exemplary embodiments, those skilled in the art will recognize that various changes and modifications may be made in form and detail without departing from the spirit and scope of the claimed subject matter.

The embodiment above was described in detail in order to explain in an easy to understand manner, but the present invention is not necessarily limited to including all configurations described, for example. A portion of the configuration of one embodiment can be replaced with the configuration of another embodiment, and a configuration of another embodiment can be added to the configuration of the one embodiment. Furthermore, other configurations can be added or removed, or replace portions of the configurations of the respective embodiments.

Further, a part or entirety of the respective configurations, functions, processing modules, processing means, and the like that have been described may be implemented by hardware, for example, may be designed as an integrated circuit, or may be implemented by software by a processor interpreting and executing programs for implementing the respective functions.

The information on the programs, tables, files, and the like for implementing the respective functions can be stored in a storage device such as a memory, a hard disk drive, or a solid state drive (SSD) or a recording medium such as an IC card, an SD card, or a DVD.

Further, control lines and information lines that are assumed to be necessary for the sake of description are described, but not all the control lines and information lines that are necessary in terms of implementation are described. It may be considered that almost all the components are connected to one another in actuality.

What is claimed is:

1. A monitoring system, comprising:
a measurement unit; and
an analysis unit,
wherein the measurement unit measures traffic information relating to messages inputted to a device to be monitored and messages outputted from the device to be monitored, and
wherein the analysis unit
calculates one or more indices on the basis of a prescribed relational expression and the measured traffic information, and
detects that a specific change in state has occurred in the device to be monitored on the basis of the indices or a comparison between a change in the indices and a threshold.

2. The monitoring system according to claim 1, further comprising:
a processing unit that classifies the measured traffic information for each device to be monitored into one or more logic nodes according to a process type of the device to be monitored,
wherein the analysis unit detects that a specific change in state has occurred in the logic node if the analysis unit has determined that one or more the indices have changed for each logic node.

3. The monitoring system according to claim 1,
wherein the analysis unit
determines a predictive value for a buffer size of the device to be monitored, and
outputs a message deletion alert if a number of messages based on the measured traffic information has exceeded the determined predictive value for the buffer size.

4. The monitoring system according to claim 3,
wherein the analysis unit
determines that messages have been deleted on the basis of the measured traffic information, and
sets a number of accumulated messages in the device to be monitored for when messages have been deleted as the predictive value for the buffer size.

5. The monitoring system according to claim 2,
wherein the analysis unit
determines a predictive value for a buffer size of the logic node, and
outputs a message deletion alert if a number of messages based on the measured traffic information has exceeded the determined predictive value for the buffer size.

6. The monitoring system according to claim 5,
wherein the analysis unit
determines that messages have been deleted on the basis of the measured traffic information, and
sets a number of accumulated messages in the logic node of the device to be monitored for when messages have been deleted as the predictive value for the buffer size.

7. The monitoring system according to claim 1,
wherein the analysis unit increases a frequency at which the traffic information is measured for another device within a predetermined distance in the network from the device to be monitored if the analysis unit detects that the device to be monitored or the logic node of the device to be monitored has undergone a change in state.

8. The monitoring system according to claim 1,
wherein the relational expression includes an arrival rate of messages to the device to be monitored that is a number of incoming messages per unit time, a message retention time in the device to be monitored, and an index that represents a performance or state of the device to be monitored.

9. The monitoring system according to claim 8,
wherein the relational expression is predetermined on the basis of queuing theory and satisfies the relation below:
Mu=Lambda+1/W.
Here, Mu is an index representing the state or performance of the device to be monitored, Lambda represents the average message arrival rate to the device to be monitored based on the number of messages within the unit time, and W is the average retention time in the device to be monitored of messages during the unit time.

10. The monitoring system according to claim 1,
wherein the analysis unit generates the threshold from the traffic information measured by the measurement unit.

11. The monitoring system according to claim 1,
wherein the analysis unit
stores a history for each index,
uses the history to calculate an amount of change for each index, and
compares the amount of change to the threshold stored in advance.

12. The monitoring system according to claim 1,
wherein the specific change in state is a fault in the device to be monitored.

13. The monitoring system according to claim 2,
wherein the specific change in state is a fault in the logic node.

14. A monitoring device, comprising:
a measurement section; and
an analysis section,
wherein the measurement section measures traffic information relating to messages inputted to a device to be monitored and messages outputted from the device to be monitored, and
wherein the analysis section
calculates one or more indices on the basis of a prescribed relational expression and the measured traffic information, and
detects that a specific change in state has occurred in the device to be monitored on the basis of the indices or a comparison between a change in the indices and a threshold.

15. A monitoring program that, by being executed by a computer, causes the computer to function as a monitoring device,
wherein the monitoring device
measures traffic information relating to messages inputted to a device to be monitored and messages outputted from the device to be monitored, and
executes:
a process of calculating one or more indices on the basis of a prescribed relational expression and the measured traffic information, and
a process of detecting that a specific change in state has occurred in the device to be monitored on the basis of the indices or a comparison between a change in the indices and a threshold.
